(19) United States
(12) Patent Application Publication
(10) Pub. No.: US 2025/0100332 A1
(43) Pub. Date: Mar. 27, 2025

(54) TIRE TRACTION DEVICE AND SYSTEM

(71) Applicant: Terratrax LLC, Springville, UT (US)

(72) Inventor: Darin Kent WOOLF, Springville, UT (US)

(21) Appl. No.: 18/896,321

(22) Filed: Sep. 25, 2024

Related U.S. Application Data
(60) Provisional application No. 63/585,026, filed on Sep. 25, 2023.

(51) Int. Cl. B60C 27/04

(52) U.S. Cl. CPC B60C 27/04

(57) ABSTRACT

A track attachment includes a track body forming a convex surface for facing a driving terrain and a concave surface for facing a wheel or tire, with at least one blade extending from the convex surface for increasing lateral traction of the wheel or tire. The at least one blade may be defined as an elongated shape extending in the direction of rotation of the wheel or tire to generate and increase in lateral traction. The track body and at least two blades may define a channel at the convex surface to generate a floating effect on soft and loose terrain. The track attachment may be provided with supporting ribs and openings for facilitating attachment to the wheel or tire. A traction system includes a plurality of track attachments secured to a wheel or tire.

### CROSS-REFERENCE TO RELATED APPLICATIONS

This application further claims the benefit of and priority to U.S. Provisional Patent Application Ser. No. 63/585,026 filed on 25 Sep. 2023, which application is expressly incorporated herein by reference in its entirety.

### BACKGROUND

### 1. The Field of the Invention

The present disclosure relates to traction systems and related devices generally adapted for mounting on the wheels of a vehicle to improve traction on certain surfaces, such as on snow, ice, sand, mud, water, etc., or in certain conditions, such as at high speeds, during significant changes in speed, during significant changes in elevation, during significant changes in direction, etc. Components of the traction systems may include individual track attachments similar to those of a continuous track system.

### 2. The Relevant Technology

Traditional wheel or tire traction is generally effective on most terrain and in most commonly presented driving conditions. These tread patterns are directly formed in the wheel or tire to provide for steering, traction, braking and load support by transmitting forces between a vehicle and a driving surface. However, with very loose, slick or soft terrain such as deep loose sand, snow and mud, traditional traction can be inadequate. Creating tires with increased traction enhancing features, such as increased tread height or metal studs, is recognized as being impractical, as these features would be useful in only limited circumstances and would be destroyed during regular use or use on hard surfaces. Accordingly, several tools are known for removably attaching to a tire and improving traction in different driving conditions. These tools are commonly referred to as tire traction devices.

Attaching any device to a wheel or tire presents several challenges at least due to the stress applied to the device during use, the limited availability of points of attachment, and limited space around the tire due to surrounding drive or frame components of the vehicle. Known tire traction devices, such as tire chains, are generally installed about a complete circumference of a tire and secured together around and enclosing the tire. While various known traction devices may employ cables or plastic straps in place of chains, the assembly of such tire traction devices is similar to those employing chains.

Improvements to known traction devices have been substantially limited by the need for such devices to be convenient to apply, securely positioned, of limited-profile, lightweight, and durable against both environmental factors and rugged use. As such, since the inception of tire chains in 1904, relatively few significant developments have occurred in the field of wheel traction devices.

Traction devices like tire chains generally include a ladder like arrangement of transverse traction elements, such as chains, connected to two parallel elements following a circumference of the wheel face. These traction devices provide generally homogeneous traction about the tire. In some known traction devices, a single transverse traction element may be independently secured about the circumference of the tire to allow for easier installation and greater adaptability with respect to the number and location of elements attached to the tire, but such individual elements are generally limited to use in emergency situations over short distances and are prone to move or rotate about the tire and out of an effective position. Even when secure, devices comprising these individual elements do not provide any substantive improvements in traction relative to tire chains or other known traction devices.

Further, while some variations in size and means of attachment are available, existing traction devices are generally designed to effectively “dig” into the surface below the tire during forward rotation thereof. While beneficial for a drive tire generating forward motion, this “digging” traction does not address lateral traction or the tendency of tires to sink into soft terrain.

The traction improvements provided by known devices are also limited outside of linear movement. While linear acceleration may be dramatically improved in certain circumstances, such as using paddle-like attachments in sand, negotiating turns remains difficult due to a tendency to slide or sink when the tire and attachment turn against the direction of momentum. A lack of lateral traction in existing devices contributes to this problem. As such, the full benefits of existing traction devices are generally restricted to attachment on drive tires, and particularly rear tires of vehicles. These drawbacks are especially evident in two-wheeled vehicles or motorcycles, where their narrow base of contact increases the risk and danger of both sliding and sinking in soft and loose terrain.

Accordingly, a need exists for a traction device capable of overcoming the deficiencies of known devices used for improving traction of a wheel or tire. In particular, a more convenient and secure coupling to a wheel, improved traction in loose terrain, reduced sinking, and improved lateral traction are highly desirable in the field of wheel traction devices and systems.

There is further a need for an adaptable traction system that may be configured to specific driving conditions at a low cost, without reducing durability of the traction system relative to known devices.

### BRIEF SUMMARY OF THE DISCLOSURE

According to embodiments of the disclosure, a track attachment is provided for use with a wheel. The track attachment may include a track body and at least one blade connected thereto. The track attachment may be removably secured to the wheel in such a manner that the track body is arranged against the wheel with the at least one blade connected to the track body opposite the wheel for improving traction and handling for a corresponding vehicle. The track attachment may form part of a traction system that can be removably attached to the wheel to adjustably configure improvements to the traction and handling of the vehicle based on driving conditions.

An exemplary track attachment may include a track body extending in a longitudinal direction from a first end to a second end and in a lateral direction perpendicular to the longitudinal direction from a first side to a second side. The track body may be shaped to match a segment of a torus shape of a wheel, the track body forming a convex surface and an opposing concave surface where the concave surface of the track body presents a curved profile for contacting the wheel.

The curved profile of the concave surface may define a longitudinal curve between the first end and the second end of the track body and a lateral curve between the first side and the second side of the track body, such that the concave surface is concave in two directions. According to various embodiments, the lateral curve may have a degree of curvature greater than a degree of curvature of the longitudinal curve. The lateral curve may correspond to a segment of a circumference of an ellipse or circle generating the substantially torus shape of the wheel and the longitudinal curve may correspond to a segment of an outer circumference of a ring substantially defined by the torus of the wheel. The track body of the track attachment may thereby be shaped to the size and shape of the wheel and provide an improved fit against the wheel, such as against a tread pattern on a crown of a tire, with improved adjustability and mounting strength.

The track attachment may include at least one blade having a base connected to the convex surface of the track body and an opposing edge spaced away from the track body, the at least one blade having a front end and a back end extending between the edge and the base, a first face and an opposing second face of the at least one blade extending between the edge and the base and also extending longitudinally between the front end and the back end.

A length of the at least one blade may be defined between the front end and the back end in the longitudinal direction and a thickness of the at least one blade may be defined between the first face and the second face in the lateral direction. The length of the at least one blade may be greater than the thickness of the at least one blade. In this manner, the at least one blade may be arranged as an elongated projection from the track body having a length extension along the circumference of the wheel, such that the first face and the second face of the at least one blade provides improved lateral traction to the wheel, particularly in soft or loose terrain such as sand, snow or mud. A height of the at least one blade may be defined between the base and the edge. In various embodiments the length of the at least one blade may be greater than the height of the at least one blade.

A size and shape of the track attachment may be configured for use with a particular size and shape of wheel and/or for certain terrain or driving conditions. According to preferred embodiments, the size of the track attachment may be configured to fit a clearance between the wheel and a frame or fender. In varying embodiments, the longitudinal curve of the track body may define a length of the track body of 8° to 40° relative to the circumference of the wheel, preferably 15° to 25°. In another aspect, the track body may have a length between the first end and the second end of 2.0 in to 9.0 in, preferably 3.5 in to 6.0 in, however, these lengths may be adjusted according to the various tire diameters for which the track body may be designed, as would be understood by one skilled in the art from the teachings of the current disclosure.

In embodiments, the track attachment may be arranged to fit a crown of the wheel, such that a width of the track body between the first side and the second side does not significantly exceed a width dimension of the wheel or tire and/or such that the at least one blade does not extend outside of the width dimension of the wheel or tire as to obstruct free rotation of the wheel. For example, the lateral curve of the track body may define a width of the track body of 30° to 120° relative to the circumference of the ellipse or circle generating the substantially lateral torus shape of the wheel or tire. In another aspect, the track body may have a width of 2.0 in to 9.0 in, preferably 3.5 in to 5.5 in. In varying embodiments, a width of the track body may exceed a width dimension of the wheel or tire, such as to maximize surface area and a floating effect realized by the track attachment.

The face of the track body that contacts the tire may have small projections or patterns in the material to provide traction between the track and tire to help keep the track from slipping from its location on the tire. These projections or patterns may extend from 0.005 inches to 0.25 inches from the body of the track.

The edge of the at least one blade may be curved, straight, or form an irregular profile when viewed along the lateral direction. For example, the edge may form a curve corresponding to the longitudinal curve of the track body or may be curved relative to the base and or the track body. An upper surface of the edge may be rounded, flat, chamfered or curved when viewed along the longitudinal direction. According to an embodiment, the edge may include one or more chamfered portions at the front end or the back end. The length of the at least one blade may also vary between the base and the edge in various embodiments. For example, the length of the at least one blade defined along the edge may be greater than the length of the at least one blade defined along the base, may be less than the length of the at least one blade defined along the base, or may be equal. These modifications to the edge of the blade may be advantageously configured to particular conditions and for providing benefits including a smoother ride, increased durability, increased traction, and an increased floating effect.

In a similar aspect, the thickness of the at least one blade may vary along a height between the base and the edge, continuously or irregularly, or may be constant. For example, a lateral cross-section of the at least one blade disposed within a central lateral plane perpendicular to the longitudinal direction may have a configuration that is at least in part circular, oval, triangular, rectangular, square, polygonal or irregular.

An edge along the height dimensions of the at least one blade may form an angle relative to an intersection point with the lateral curve, the angle defining an orientation of the at least one blade. In varying examples, the at least one blade may be oriented at 45°, 90°, or from 30° to 90°.

A size and shape of the at least one blade may be advantageously configured to the particular wheel or terrain in which it is intended to be used. For example, the at least one blade may be configured to have a greater height for use in softer and/or looser terrain where increased surface area of the first face and the second face are preferred for improving lateral traction. In like manner, the height of the at least one blade may be configured to provide a predetermined space between the at least one blade and a component of the vehicle. Accordingly, the track attachment may be configured in a set of predetermined sizes, such as small, medium or large. Embodiments of the at least one blade may have a height of 0.5 in, 1.0 in, 2.0 in, 2.5 in, or between 0.5 in and 3.0 in, although these heights may be adjusted according to the various tire diameters, vehicles and terrain for which the track body may be designed, as would be understood by one skilled in the art from the teachings of the current disclosure.

In another aspect, the length of the at least one blade may be at least 50% of the length of the track body, at least 75%, at least 85%, at least 90%, or at least 95%. In an example a minimum length of the at least one blade may be at least 50% of the length of the track body, at least 75%, at least 85%, at least 90%, or at least 95%. In another example, the length of the blade may be greater than the length of the track body.

Embodiments of the track attachment may include one blade or a plurality of blades, for example one, two or three blades, or more than three blades. Each of the plurality of blades may be of equal shape, orientation and size, or may be different. Two of the plurality of blades may define a channel with the track body, such that the track attachment may have a substantially “U”-shaped, “V”-shaped, or even “W”-shaped profile when viewed along the longitudinal direction. The channel formed by the two of the plurality of blades has been surprisingly found to provide a floating effect to the wheel in soft and loose terrain where known traction devices and traditional tires tend to sink. By this “floating” effect, handling and steering are dramatically improved over known devices at high and low speeds.

In an embodiment, the at least one blade may comprise a single, central blade connected to the convex surface along a central longitudinal axis perpendicular to the lateral direction. In another embodiment, the at least one blade may comprise two blades, the two blades including a first lateral blade and a second lateral blade. The first lateral blade and the second lateral blade may be equally spaced apart from the central longitudinal axis and/or equally spaced apart from the first side and the second side of the track body respectively. In one aspect, the first lateral blade and the second lateral blade may be parallel. The first lateral blade and the second lateral blade may connect to the track body at the first side and the second side of the track body respectively. Embodiments of the track attachment having three blades may include a first lateral blade, a second lateral blade and a central blade as discussed above.

The track attachment may include a plurality of ribs connected to the at least one blade. The ribs may be arranged to buttress the at least one blade in the lateral direction and may connect the first face and/or the second face to the convex surface of the track body. In varying embodiments, the ribs may form an angle of 90° with the at least one blade, or an angle of 60° to 90° (e.g., up to 30° from lateral). In some embodiments, a plurality of ribs may extend from one of the first face and the second face of the at least one blade below the concave surface, such that the plurality of ribs buttress the at least one blade against the wheel during use. The ribs advantageously reinforce the at least one blade without increasing the weight of the track attachment while advantageously increasing traction in the longitudinal direction.

An embodiment of the track attachment may comprise a plurality of projections, bumps, recesses, or the like arranged on a surface of the track body, a surface of the at least one blade and/or a surface of the plurality of ribs for increasing friction between the track attachment and surrounding objects and/or terrain. In a specific embodiment, the plurality of projections may be arranged on the concave surface of the track body and may be configured with a size and shape corresponding to a tread pattern of a tire. For example, the plurality of projections may be configured to fit into recesses of the tread pattern. The plurality of projections may be formed by metal inserts or another more rigid material, or may be formed in the material of the at least one blade or the track body.

One or more of the track body and the at least one blade may define openings or cavities therethrough, the openings or cavities configured for receiving a connector, such as a cord, line, strap or the like. The openings or cavities of varying embodiments may be dimensioned and shaped for improving an attachment to a connector, such as by forming a shape or size configured for securing the connector. In some embodiments, multiple openings or cavities may be arranged in concert with the ribs or other projections on the track body forming a channel for passing a connector therethrough, such as along a length of the track body, advantageously tensioning the length of the track body in a desired position.

In one aspect, at least one opening may be provided on each of the first side and the second side of the track body. In another example, at least two openings may be provided on each of the first side and the second side of the track body. In a further aspect, each of the at least two openings on each of the first side and the second side may be provided with an independent connector for securing to the wheel, such as to spokes of the wheel. The track attachment may be secured to the wheel using tensioned connectors.

Embodiments of the track attachment may be symmetrical, for example about the central longitudinal plane, about the central lateral plane, or both the central longitudinal plane and the central lateral plane. Symmetry of the track attachment may advantageously ensure a consistent enhancement to traction and handling. Symmetric track attachments may advantageously increase convenience in mounting the attachments without significantly affecting the benefits to traction.

The track attachment may be formed from a single material or from a plurality of materials, including metallic components or portions, plastic components or portions, rubber components or portions, or combinations thereof. Portions of the track attachment may be configured to have different material properties, whether or not including the same or different materials. For example, the track attachment may be arranged with at least one blade that is flexible relative to the ribs or the track body such that, when in use, a channel defined by the at least one blade and the track body has a variable size while in contact with the ground, without losing its shape over time. Such variation in the channel may advantageously improve the floating effect of the track attachments of the current disclosure, enabling the wheel to float or ride on top of soft or loose terrain without sinking, and/or improving lateral traction.

In another aspect, the track body may be configured to be flexible in order to fit to multiple tires having different shapes or sizes while the at least one blade is configured to be more rigid for increasing traction in soft or loose terrain. Flexible or resilient portions of the track attachments may be deformed due to a weight of the vehicle and the firmness of the terrain without substantially losing their shape. In this manner, the resilient or flexible portions may provide improved fit against the wheel, smoother handling, smoother riding, and improved traction. The track attachment may be flexible by either the use of hinges or material pliability. The space on the track body not occupied by at least one blade may be thinner in certain areas to accommodate such flexibility.

The track attachment may be integrally formed or molded from a suitable material, or may be formed from a combination of materials, for example insert molded. Suitable materials are preferably moldable in manufacturing and resilient, or suitably rigid and strong to withstand pressure and remaining durable in use and may include plastics, thermoplastics, or plastic/thermoplastic compounds and light weight metals or metal alloys. Examples of such materials include polyurethane, thermoplastic polyurethane, polyamide and aluminum. In certain embodiments, a thermoplastic vulcanizate alloy may be used. In some embodiments, the materials may include thermoplastic elastomers. Additional materials suitable for use will be recognized by one skilled in the art from the description of the embodiments of the current application.

Embodiments of the track attachment may form part of a track system for a vehicle. The track system may include a plurality of track attachments secured about a wheel of the vehicle. According to an advantageous embodiment, the wheel may comprise a front wheel, more particularly a front wheel of a two-wheel vehicle or motorcycle.

In various aspects of the system, the track system may include at least 3 track attachments, at least 4 track attachments, 3 to 20 track attachments, 5 to 15 track attachments, or 6 to 12 track attachments. In certain embodiments, each of the track attachments in the system may be identical. In alternative embodiments, the plurality of track attachments may be different. For example, the plurality of track attachments may be configured having different numbers of blades, sizes, or blade orientations. Each of the plurality of track attachments may include one or more of a first lateral blade, a second lateral blade, and/or a central blade, for example the traction system may include a plurality of track attachments alternating between a first lateral blade and a second lateral blade around the wheel.

The plurality of track attachments may be evenly spaced about the circumference of the wheel. Each of the track attachments may be secured to spokes of the wheel or around a circumference of the wheel by connectors passing through openings in the track attachments. In an advantageous embodiment, each of the track attachments may be provided with at least two independent connectors, such that each track attachment is secured to the wheel at two opposite sides of the track attachment. In another aspect, each of the plurality of track attachments may be secured to at least two other track attachments by connectors passing through the openings in the track attachments.

The connectors may comprise any suitable materials and may vary in size, number, and dimensions. In an embodiment, the connectors may comprise a redundant connection system including securing straps and a redundant safety strap. The securing straps may be arranged to secure the track attachment to the spokes or a similar portion of the wheel, and to other track attachments according to some embodiments, while the redundant safety strap may be configured to wrap around the circumference of the tire or wheel in the lateral direction. The redundant safety strap may be configured to be substantially larger than the securing straps and may attach to the track attachment along a midline of the track attachment. In some embodiments, the track attachments may be secured with only one strap configured to wrap around the circumference of the tire or wheel in the lateral direction, or with multiple straps configured to wrap around the circumference of the tire or wheel in the lateral direction.

An embodiment of a redundant connection system may include a plurality of securing straps connecting the track attachment to the spokes of the wheel from at least four corners of the track attachment and a redundant safety strap wrapping around the circumference of the wheel in the lateral direction. The plurality of securing straps may serve to tension the track attachment against the curve of the wheel or tire and prevent it from slipping out of position, while the redundant safety strap ensures the track attachment does not separate from the wheel. The redundant nature of the connection system allows for a secure and safe fit without impairing the blades of the track attachment or requiring significant increases in weight and/or materials required for the traction system.

Embodiments of the track attachment and traction system of the current disclosure may be used in a corresponding method for mounting to a wheel and/or operating a vehicle.

The above embodiments solve the problem of traction devices having low adjustability and being difficult to use, by providing an improved track attachment and traction system with increased adjustability and simplicity. The track attachment provides an increased flexibility of placement of said track attachments and may be easily fitted and secured to particular wheels or tires.

The above embodiments further solve the problem of limited lateral traction and a tendency to sink in loose or soft terrain common to existing traction devices, by providing an improved track attachment and traction system with increased lateral traction and exhibiting a novel floating effect.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 shows a perspective view illustrating a track attachment according to an embodiment of the disclosure.

FIG. 2 is a front view of the track attachment of FIG. 1.

FIG. 3A is a top view of the track attachment of FIG. 1.

FIG. 3B is a bottom view of the track attachment of FIG. 1.

FIG. 4 is a side view of the track attachment of FIG. 1.

FIG. 5 shows a perspective view illustrating a track attachment according to an embodiment of the disclosure.

FIG. 6 is a front view of the track attachment of FIG. 5.

FIG. 7A is a top view of the track attachment of FIG. 5.

FIG. 7B is a bottom view of the track attachment of FIG. 5.

FIG. 8 is a side view of the track attachment of FIG. 5.

FIG. 9 shows a perspective view illustrating a track attachment according to an embodiment of the disclosure.

FIG. 10 is a front view of the track attachment of FIG. 9.

FIG. 11A is a top view of the track attachment of FIG. 9.

FIG. 11B is a bottom view of the track attachment of FIG. 9.

FIG. 12 is a side view of the track attachment of FIG. 9.

FIG. 13 shows a perspective view illustrating a track attachment according to an embodiment of the disclosure.

FIG. 14 is a front view of the track attachment of FIG. 13.

FIG. 15A is a top view of the track attachment of FIG. 13.

FIG. 15B is a bottom view of the track attachment of FIG. 13.

FIG. 16 is a side view of the track attachment of FIG. 13.

FIG. 17 is a perspective view of a traction system according to an embodiment of the disclosure.

FIG. 18 shows a top perspective view illustrating a track attachment according to an embodiment of the disclosure.

FIG. 19 shows a bottom perspective view of the track attachment of FIG. 18.

The drawing figures are not necessarily drawn to scale, but instead are drawn to provide a better understanding of the components, and are not intended to be limiting in scope, but to provide exemplary illustrations. The figures illustrate exemplary configurations of track attachments and traction systems including track attachments, and in no way limit the structures, configurations or functions of embodiments according to the present disclosure.

### DETAILED DESCRIPTION

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. The dimensions, angles, and curvatures represented in the figures introduced above are to be understood as exemplary and are not necessarily shown in proportion. The embodiments of the disclosure are adapted for a wheel or tire, and may be dimensioned to accommodate different types, shapes, and sizes of the same.

It should be understood, however, there is no intention to limit the disclosure to the specific embodiments disclosed, but on the contrary, the intention covers all modifications, alternative constructions, combinations, and equivalents falling within the spirit and scope of the disclosure. It is also to be understood that the terminology used herein is only for the purpose of describing particular embodiments of the present disclosure, and is not intended to limit the scope of the disclosure.

For further case of understanding the embodiments of a traction system and variants as disclosed, a description of a few terms may be useful. The terms “rigid,” “flexible,” and “resilient” may distinguish characteristics of portions of certain features of the track attachment and the traction system. The term “rigid” should denote that an element is generally devoid of flexibility. Within the context of features that are “rigid,” it should indicate that they do not lose their overall shape when force is applied and may break if bent with sufficient force. The term “flexible” should denote that features are capable of repeated bending such that the features may be bent into retained shapes or the features do not retain a general shape, but continuously deform when force is applied.

The term “flexible” may qualify such features as generally conforming to the shape of another object when placed in contact therewith, via any suitable natural or applied forces, such as gravitational forces, or forces applied by external mechanisms, for example, through connection to a wheel or tension of related connectors. The terms “resilient” or “semi-rigid” may qualify such flexible features as generally resisting deformation until sufficient force is applied and returning to an initial general shape without permanent deformation.

Moreover, the terms top, under, front, back, end, base, edge and the like in the description and the claims are used for descriptive purposes and not necessarily for describing relative positions. It is to be understood that the terms so used are interchangeable under appropriate circumstances and that the embodiments of the disclosure described herein are capable of operation in other orientations than described or illustrated herein.

It is to be noticed that the term “comprising,” which is synonymous with “including,” “containing,” “having” or “characterized by,” should not be interpreted as being restricted to the means listed thereafter; it does not exclude other or additional, unrecited elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present disclosure, the relevant components of the device are A and B.

It will be noted that, as used in this specification and the appended claims, the singular forms “a,” “an” and “the” include plural referents unless the content clearly dictates otherwise. Thus, for example, reference to a “blade” includes one, two, or more blades.

Reference throughout this specification to “one embodiment,” “one aspect,” or “an embodiment” means that a particular feature, structure or characteristic described in connection with the embodiment is included in at least one embodiment of the present disclosure. As used herein, the term “embodiment” or “aspect” means “serving as an example, instance, or illustration,” and should not necessarily be construed as preferred or advantageous over other embodiments disclosed herein. Thus, appearances of the phrases “in one embodiment,” “in one aspect,” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

Similarly, it should be appreciated that in the description of exemplary embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the embodiments require more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this disclosure.

Furthermore, while some embodiments described herein include some, but not other features included in other embodiments, combinations of features of different embodiments are meant to be within the scope of the disclosure, and form different embodiments, as would be understood by those in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Unless defined otherwise, all technical and scientific terms used herein have the same meaning as commonly understood by one of ordinary skill in the art to which the present disclosure pertains. Although a number of methods and materials similar or equivalent to those described herein can be used in the practice of the present disclosure, the preferred materials and methods are described herein.

The various embodiments of the disclosure relate to a track attachment for use with a traction system and generally adapted for mounting on a wheel of a vehicle resulting in improved traction and handling. The track attachments and related traction systems provide improved adjustability and improved attachment to a wheel or tire, resulting in a simple and adaptable assembly having increased compatibility with a plurality of wheel shapes and sizes while increasing traction and handling relative to known systems.

Although the exemplary embodiments of the disclosure are shown and described for a single wheel or tire, the embodiments of the disclosure may also be adapted to accommodate different numbers of wheels and/or vehicles. Accordingly, the embodiments of the disclosure are not limited to use with a single wheel, with a front wheel, or with a motorcycle, but may be applied to any wheel or vehicle where it is necessary to improve traction and handling, such as in soft or loose terrain, as would be understood from the disclosure by one of ordinary skill in the art.

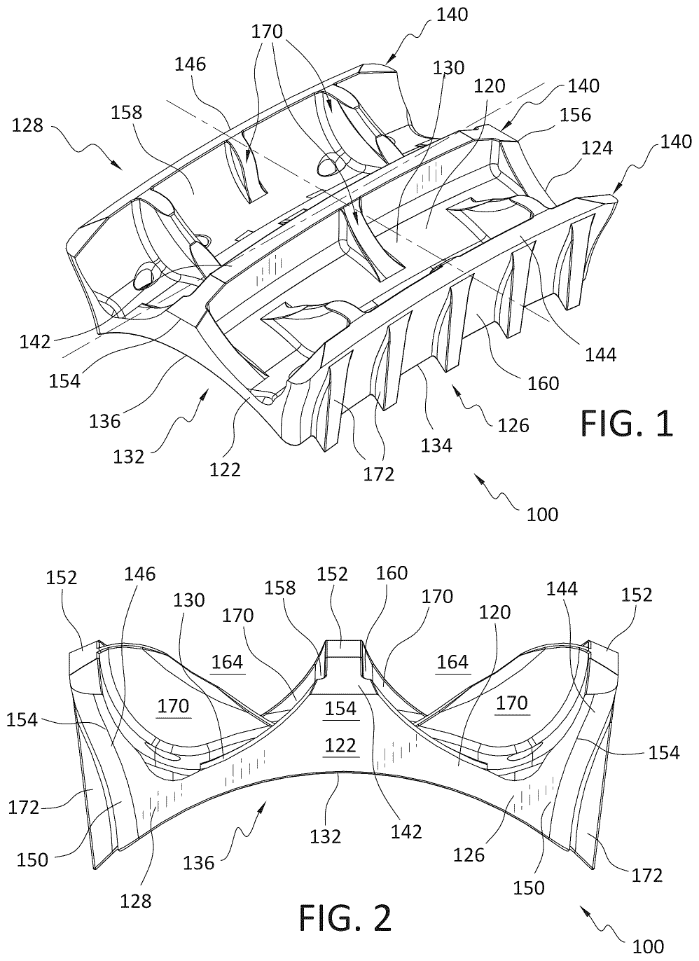

Depicted in FIG. 1 is one embodiment of a track attachment 100 incorporating features of the present disclosure. As discussed below in more detail, track attachment 100 is configured to interface between a wheel and driving terrain, and is designed for improving traction and handling. The driving terrain can include soft or loose terrain, or any other surface or material on or through which the wheel may pass.

As depicted in FIGS. 1-4, track attachment 100 generally comprises a track body 120 extending in a longitudinal direction from a first end 122 to a second end 124 and in a lateral direction perpendicular to the longitudinal direction from a first side 126 to a second side 128. In the depicted embodiment, the track body 120 is shaped to match a segment of a torus shape of a wheel, the track body forming a convex surface 130 and an opposing concave surface 132 where the concave surface 132 of the track body presents a curved profile for contacting the wheel.

The curved profile of the concave surface 132 defines a longitudinal curve 134 between the first end 122 and the second end 124 of the track body 120 and a lateral curve 136 between the first side 126 and the second side 128 of the track body 120, such that the concave surface 132 is concave in two directions. The lateral curve 136 has a degree of curvature greater than a degree of curvature of the longitudinal 134 curve, such that in use the longitudinal curve 134 extends along a rotating circumference of a substantially torus-shaped wheel or tire while the lateral curve 136 fits across a crown of the wheel or tire in an opposite direction. The lateral curve 136 may correspond to a segment of a circumference of an ellipse or circle generating the substantially torus shape of the wheel and the longitudinal curve 134 may correspond to a segment of an outer circumference of a ring substantially defined by the torus of the wheel. The track body 120 of the track attachment 100 may thereby be shaped to the size and shape of the wheel and provide an improved fit against the wheel, such as against a tread pattern on the crown of a tire, with improved adjustability and mounting strength.

It should be noted that, while described as having a particular shape according to the embodiment of FIGS. 1-4, embodiments of the current disclosure do not exclude the possibility of the track attachment 100 being configured with a flexibility or resiliency such that the track attachment 100 or portions thereof adopt a shape of a surface it is mounted to. For example, the track body may be configured to bend about a surface of a tire, for example in two directions, in response to tension and retain said shape/position in response to continued tension or as a result of the materials used in forming the track attachment.

The track attachment 100 may include at least one blade 140 connected to the track body 120. The at least one blade 140 includes a base 150 connected to the convex surface 130 of the track body 120 and an opposing edge 152 spaced away from the track body 120, the at least one blade 140 having a front end 154 and a back end 156 extending between the edge 152 and the base 150, a first face 158 and an opposing second face 160 of the at least one blade 140 extending between the edge 152 and the base 150 and also extending between the front end 154 and the back end 156.

A length of the at least one blade 140 may be defined between the front end 154 and the back end 156 in the longitudinal direction and a thickness of the at least one blade 140 may be defined between the first face 158 and the second face 160 in the lateral direction. A height of the at least one blade 140 may be defined between the base 150 and the edge 152.

As shown in FIG. 1, the at least one blade 140 of the depicted embodiment includes a central blade 142, a first lateral blade 144 and a second lateral blade 146. The central blade 142 is positioned along a central longitudinal axis of the track attachment 100 perpendicular to the lateral direction, the central blade 142 substantially dividing the track body 120 at a midline of the track body located between the first side 126 and the second side 128. The first lateral blade 144 is spaced apart from the central blade 142, being positioned at a termination of the first side 126 of the track body 120. The second lateral blade 146 is similarly spaced apart from the central blade 142, being positioned at a termination of the second side 128 of the track body 120.

In various embodiments the first lateral blade 144 may be spaced apart from the first side 126 and/or the second lateral blade 146 may be spaced apart from the second side 128. For example, the first lateral blade 144 may be spaced apart from the first side 126 and the second lateral blade 146 may be spaced apart from the second side 128 at equal distances. In another aspect, the first lateral blade 144 and the second lateral blade 146 may be equally spaced apart from the central blade 142. In a similar aspect, as seen in FIGS. 1 and 2, the track attachment 100 may be substantially symmetrical about a central longitudinal plane extending perpendicular to the lateral direction and parallel to the longitudinal direction.

As illustrated in the embodiments of FIGS. 1 and 2, the edges 152 of the central blade 142, the first lateral blade 144, and the second lateral blade 146 may be substantially parallel and/or curved along the longitudinal direction. In the depicted embodiment, the edge 152 of the central blade 142 is substantially flat in the lateral direction and curved in the longitudinal direction, while the edges 152 of the first lateral blade 144 and the second lateral blade 146 are curved in the longitudinal direction in a manner substantially equal to the edge 152 of the central blade 142 and the front end 154 and the back end 156 meet the edge 152 at a chamfered portion. However, rather than being flat, the edges 152 of the first lateral blade 144 and the second lateral blade 146 are curved or slanted in the lateral direction, the curve or slant of the first lateral blade 144 and the second lateral blade 146 being essentially mirror opposites.

Varying additional embodiments may modify an orientation of one or more of the blades 140 in the longitudinal direction such that one or more of the blades 140 is not substantially parallel with another, and/or such that one or more of the edges 152 are not curved, are irregularly curved, or are all equally curved. A degree of curvature of one or more of the edges 152 may be equal to the longitudinal curve 134 or may be different.

As illustrated in the embodiment of FIGS. 1-4, the length of the blades 142, 144, 146 is greater than both the thickness and the height of the blades 142, 144, 146, the blades 142, 144, 146 each forming an elongated projection on the convex surface 130 of the track body 120. The blades 142, 144, 146 are shown substantially equal in length, with each of the blades 142, 144, 146 extending from the first end 122 to the second end 124 of the track body 120 in the longitudinal direction. While shown having substantially equal length dimensions, one or more of the at least one blade may be configured with a length different than that of one or another of the at least one blade 140. For example, the embodiment of FIG. 1 may be configured such that one or more of the blades 142, 144, 146 has a lesser or greater length, such as where the central blade 142 is shorter or longer than the first lateral blade 144 and/or the second lateral blade 146 or similar configurations. As shown in FIG. 2, the height of the central blade 142 may be less than the height of the first lateral blade 144 and the second lateral blade 146, however, due to the lateral curve 136, the edges 152 of each of the blades 142, 144, 146 may terminate in a common horizontal plane.

According to the embodiment of FIGS. 1-4, the blades 142, 144, 146 and the track body 120 may define one or more channels 164 on the convex surface 130. As seen in FIG. 2, the blades 142, 144, 146 and the track body 120 may form a substantially “W-shaped” profile when viewed along the longitudinal direction, with a channel 164 formed between the central blade 142 and the first lateral blade 144, as well as between the central blade 142 and the second lateral blade 146. In this configuration, the parallel channels 164 extending along the longitudinal direction provide an advantageous floating effect, where material may fill the channels and generate an upward force, preventing the wheel from penetrating or sinking deeply into the terrain.

The track attachment 100 may include a plurality of ribs 170 connected to the at least one blade 140. The ribs 170 may be arranged to buttress the at least one blade 140 in the lateral direction, and may connect the first face 158 and/or the second face 160 to the convex surface 130 of the track body 120. In varying embodiments, the ribs 170 may form an angle of 90° with the at least one blade, or an angle of 60° to 90° (e.g., up to 30° from lateral). In some embodiments, a plurality of ribs 170 may extend from one of the first face 158 and the second face 160 of the at least one blade 140 below the concave surface 132, such that the plurality of ribs 170 buttress the at least one blade 140 against the wheel during use. The ribs 170 advantageously reinforce the at least one blade 140 without significantly increasing the weight of the track attachment 100.

As depicted in the embodiment of FIGS. 1-4, a plurality of ribs 170 may be arranged between the blades 142, 144, 146 and the convex surface 130 of the track body 120, the ribs forming lateral supports for the blades 142, 144, 146 in the channels 164 as well as having a height sufficient to provide increased longitudinal traction during rotation of the wheel. These lateral supports may have a lateral extension greater than a height thereof, for advantageously increasing the lateral strength of the blades 142, 144, 146 and the track body 120. In a similar manner, the ribs 170 may have a height that decreases from the attachment with the at least one blade 140 along the lateral extension.

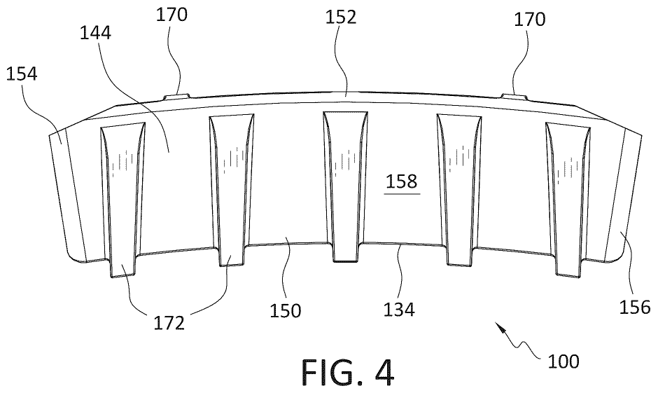

The plurality of ribs 170 according to the depicted embodiment further includes exterior ribs 172 extending outward, continuing the concave surface 132, such that the exterior ribs 172 buttress the first lateral blade 144 and the second lateral blade 146 against the wheel during use. As clearly seen in FIGS. 2 and 4, the arrangement of the exterior ribs 172 of this embodiment advantageously restrict a flared shape of the first lateral blade 144 and the second lateral blade 146 in response to stress without high material costs or corresponding increases in weight, increasing durability and maintaining the beneficial floating effect of the blades 142, 144, 146 and the channels 164 without increasing the cost or complexity of the track attachment 100. By the exterior ribs 172 extending the concave surface 132, the track attachment 100 may also better conform and dynamically respond to the shape of a corresponding wheel or tire on which the track attachment 100 is mounted.

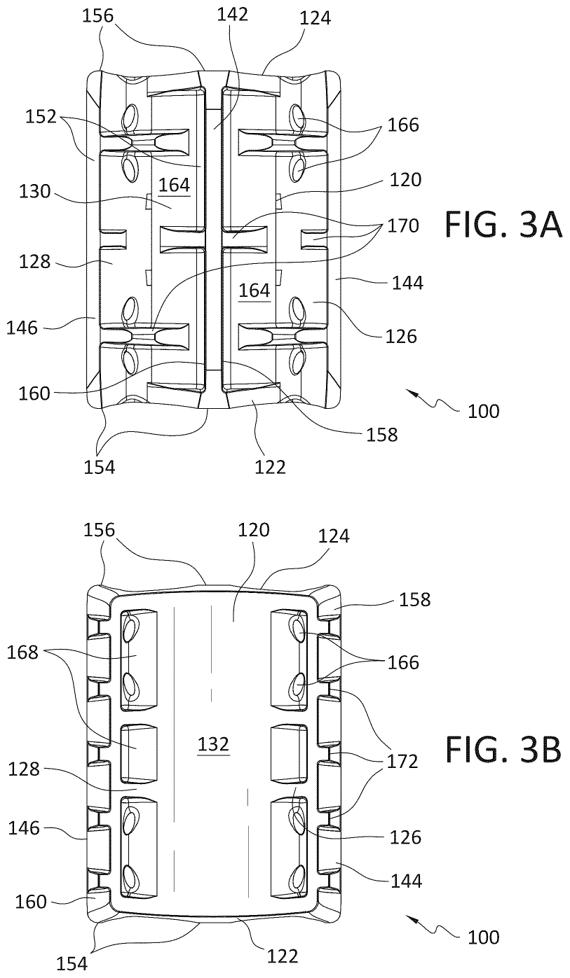

One or more of the track body 120 and the at least one blade 140 may define openings 166 therethrough, the openings 166 configured for receiving a connector (not shown), such as a cord, line, strap or the like. The openings 166 of varying embodiments may be dimensioned and shaped for improving an attachment to a connector, such as by forming a shape or size configured for securing the connector. As illustrated in FIGS. 3A and 3B, the openings 166 may be provided on each of the first side 126 and the second side 128 of the track body 120, as well as at the first end 122 and the second end 124, such as in each corner of the track body 120. The openings 166 may be provided in pairs, as seen in FIGS. 3A and 3B such that a connector may loop through a pair of openings 166 to secure the track attachment 100 in place against a wheel or tire.

Placement of the openings 166 may be adapted to increase desirable properties of the track attachment 100. For example, placement of the openings 166 in corners of the track body 120 may allow the track body 120 to be secured to the wheel at four opposing points, beneficially increasing the strength of attachment. As clearly seen in FIG. 3A, the openings 166 may be arranged relative to ribs 170, such that a connector looping through a pair of openings 166 secures about one of the ribs 170. This configuration advantageously increases the strength of the track attachment 100 at a point of attachment, due to the increased thickness of the ribs 170, and may also provide a counter force to the first lateral blade 144 and the second lateral blade 146 for limiting a flared shape of the first lateral blade 144 and the second lateral blade 146 in response to stress for certain embodiments.

As can be seen in FIG. 3B, portions of the track body 120 and/or the at least one blade 140 may be hollow. The hollow portions 168 may be configured to reduce a weight of the track attachment 100, provide for improved moldability, allow space for a connector or strap device, and/or to provide variations in strength along certain areas of the track attachment 100.

A size and shape of the track attachment 100 may be configured for use with a particular size and shape of wheel and/or for certain terrain or driving conditions. According to preferred embodiments, the size of the track attachment 100 may be configured to fit a clearance between the wheel and a frame. In varying embodiments, the longitudinal curve 134 of the track body 120 may define a length of the track body 120 of 8° to 30° relative to the circumference of the wheel, preferably 15° to 25°. In another aspect, the track body 120 may have a length between the first end 122 and the second end 124 of 2.5 in to 9.0 in, preferably 3.5 in to 6.0 in.

In embodiments, the track attachment 100 may be arranged to fit a crown of the wheel, such that a width of the track body 120 between the first side 126 and the second side 128 does not substantially exceed a width dimension of the wheel and/or such that the at least one blade 140 does not extend outside of the width dimension of the wheel. For example, the lateral curve 136 of the track body 120 may define a width of the track body 120 of 30° to 120° relative to the circumference of the ellipse or circle generating the substantially torus shape of the wheel. In another aspect, the track body 120 may have a width of 2.0 in to 9.0 in, preferably 3.5 in to 5.5 in.

In a similar aspect, the thickness of the at least one blade 140 may vary along a height between the base 150 and the edge 152, continuously or irregularly, or may be constant. For example, a lateral cross-section of the at least one blade 140 disposed within a central lateral plane perpendicular to the longitudinal direction may have a configuration that is at least in part circular, oval, triangular, rectangular, square, polygonal or irregular. A center axis along the height dimensions of the at least one blade 140 may form an angle relative to an intersection point with the lateral curve 136, the angle defining an orientation of the at least one blade 140. In varying examples, the at least one blade may be oriented at 45°, 90°, or from 30° to 90°.

A size and shape of the at least one blade 140 may be configured to the particular wheel or terrain in which it is intended to be used. For example, the at least one blade 140 may be configured to have a greater height for use in softer and/or looser terrain where increased surface area of the first face 158 and the second face 160 are preferred for improving lateral traction. In like manner, the height of the at least one blade 140 may be configured to provide a predetermined space between the at least one blade 140 and a component of the vehicle. Accordingly, the track attachment may be configured in a set of predetermined sizes, such as small, medium or large. Embodiments of the at least one blade may have a height of 0.5 in, 1.0 in, 2.0 in, 2.5 in, or between 0.5 in and 3.0 in, although these heights may be adjusted according to the various tire diameters, vehicles and terrain for which the track body may be designed, as would be understood by one skilled in the art from the teachings of the current disclosure.

In another variation, the track attachment 100 may have a pyramidal profile tapering in the direction opposite the wheel, such that at least a slight inward angle is formed on each of four sides of the track attachment 100. In this manner, interference between the track attachment 100 and components of a vehicle may be minimized.

In another aspect, the length of the at least one blade 140 may be at least 50% of the length of the track body 120, at least 75%, at least 85%, at least 90%, or at least 95%. In an example a minimum length of the at least one blade 140 may be at least 50% of the length of the track body 120, at least 75%, at least 85%, at least 90%, or at least 95%. In another example, the length of the blade 140 may be greater than the length of the track body 120. In another aspect, a minimum length of the at least one blade extending from the front end to the back end in the longitudinal direction is greater than a maximum thickness of the at least one blade extending from the first face to the second face in the lateral direction, for example at least 1.5 times the maximum thickness.

The track attachment 100 may be formed from a single material or from a plurality of materials, including metallic components or portions, plastic components or portions, rubber components or portions, or combinations thereof. Portions of the track attachment 100 may be configured to have different material properties, whether or not including the same or different materials. For example, the track attachment 100 may be arranged with at least one blade 140 that is flexible relative to the ribs 170, 172 or the track body 120 such that, when in use, the channel 164 defined by the at least one blade 140 and the track body 120 has a variable size without losing its shape. Such variation in the channel may advantageously improve the floating effect of the track attachments 100 of the current disclosure, enabling the wheel to float or ride on top of soft or loose terrain without sinking, and/or improving lateral traction.

In another aspect, the track body 120 may be configured to be flexible in order to fit to multiple tires having different shapes or sizes while the at least one blade 140 is configured to be more rigid for increasing traction in soft or loose terrain. Flexible or resilient portions of the track attachments 100 may be deformed due to a weight of the vehicle and the firmness of the terrain without substantially losing their shape. In this manner, the resilient or flexible portions may provide improved fit against the wheel, smoother handling, smoother riding, and improved traction.

The track attachment 100 may be integrally formed or molded from a suitable material, or may be formed from a combination of materials, for example insert molded. Suitable materials are preferably moldable in manufacturing and resilient, or suitably rigid and strong to withstand pressure and remaining durable in use and may include plastics, thermoplastics, or plastic/thermoplastic compounds and light weight metals or metal alloys. Examples of such materials include polyurethane, polyamide and aluminum. In certain embodiments, a thermoplastic vulcanizate alloy may be used. In some embodiments, the materials may include thermoplastic elastomers. Additional materials suitable for use will be recognized by one skilled in the art from the description of the embodiments of the current application.

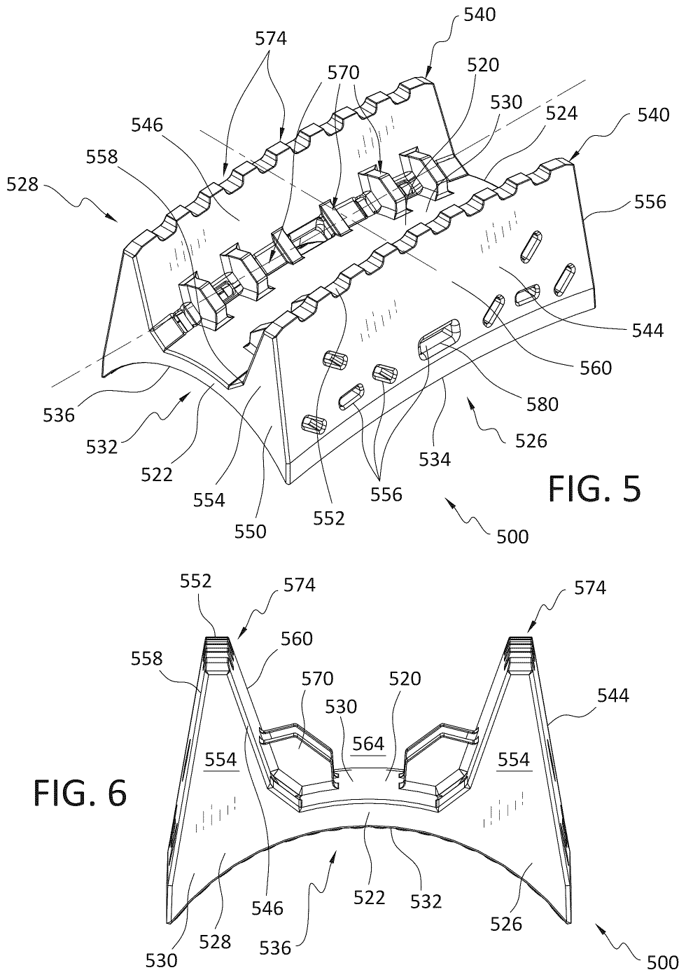

FIG. 5 illustrates an embodiment of a track attachment 500 incorporating features of the present disclosure. As discussed with respect to the embodiment of FIGS. 1-4, the track attachment 500 is configured to interface between a wheel and driving terrain, and is designed for improving traction and handling. The driving terrain can include soft or loose terrain, or any other surface or material on or through which the wheel may pass.

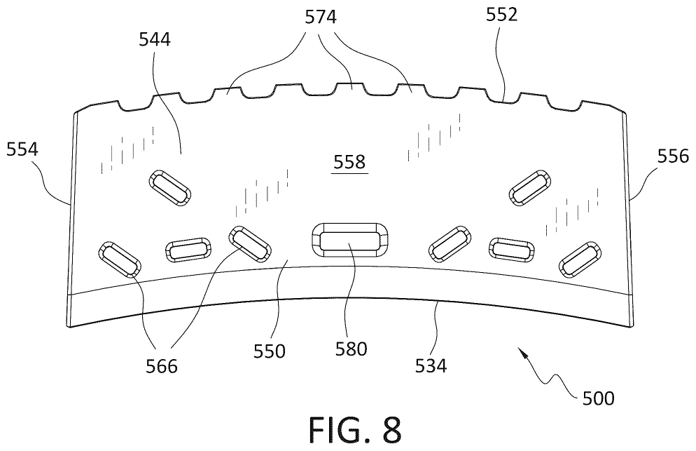

As depicted in FIGS. 5-8, track attachment 500 generally comprises a track body 520 extending in a longitudinal direction from a first end 522 to a second end 524 and in a lateral direction perpendicular to the longitudinal direction from a first side 526 to a second side 528. In the depicted embodiment, the track body 520 is shaped to match a segment of a torus shape of a wheel, the track body forming a convex surface 530 and an opposing concave surface 532 where the concave surface 532 of the track body presents a curved profile for contacting the wheel.

The curved profile of the concave surface 532 defines a longitudinal curve 534 between the first end 522 and the second end 524 of the track body 520 and a lateral curve 536 between the first side 526 and the second side 528 of the track body 520, such that the concave surface 532 is concave in two directions. The lateral curve 536 has a degree of curvature greater than a degree of curvature of the longitudinal 534 curve, such that in use the longitudinal curve 534 extends along a rotating circumference of a substantially torus-shaped wheel or tire while the lateral curve 536 fits across a crown of the wheel or tire in an opposite direction. The lateral curve 536 may correspond to a segment of a circumference of an ellipse or circle generating the substantially torus shape of the wheel and the longitudinal curve 534 may correspond to a segment of an outer circumference of a ring substantially defined by the torus of the wheel. The track body 520 of the track attachment 500 may thereby be shaped to the size and shape of the wheel and provide an improved fit against the wheel, such as against a tread pattern on the crown of a tire, with improved adjustability and mounting strength.

The track attachment 500 may include at least one blade 540 connected to the track body 520. The at least one blade 540 includes a base 550 connected to the convex surface 530 of the track body 520 and an opposing edge 552 spaced away from the track body 520, the at least one blade 540 having a front end 554 and a back end 556 extending between the edge 552 and the base 550, a first face 558 and an opposing second face 560 of the at least one blade 540 extending between the edge 552 and the base 550 and also extending between the front end 554 and the back end 556.

A length of the at least one blade 540 may be defined between the front end 554 and the back end 556 in the longitudinal direction and a thickness of the at least one blade 540 may be defined between the first face 558 and the second face 560 in the lateral direction. A height of the at least one blade 540 may be defined between the base 550 and the edge 552.

As shown in FIG. 5, the at least one blade 540 of the depicted embodiment includes a first lateral blade 544 and a second lateral blade 546. The first lateral blade 544 is spaced apart from the second lateral blade 546, being positioned at a termination of the first side 526 of the track body 520 while the second lateral blade 546 is similarly positioned at a termination of the second side 528 of the track body 520.

As best seen in FIG. 6, each of the first lateral blade 544 and the second lateral blade 546 have a substantially “A-frame” shape when viewed along the longitudinal direction, the first lateral blade 544 and the second lateral blade 546 together forming a substantially “U-shape” defining a channel 564 there between. The arrangement of the track attachment 500 allows for an improved lateral traction and provides the surprising floating effect when used with soft surfaces.

In the depicted embodiment, a plurality of ribs 570 are provided in the channel 564 connecting the blades 544, 546 with the track body 520. In a variation from the embodiment of FIGS. 1-4, the ribs 570 form straight, flat faces rather than a continuously sloped profile. In another aspect, the ribs 570 of the first lateral blade 544 and the second lateral blade 546 do not overlap in the channel 564.

As illustrated in the embodiment of FIGS. 5 and 6, the edges 552 of the first lateral blade 544 and the second lateral blade 546 may be substantially parallel and/or curved along the longitudinal direction. In the depicted embodiment, the edges 552 of the first lateral blade 544 and the second lateral blade 546 are curved in the longitudinal direction in a manner substantially equal to the longitudinal curve 534 and substantially flat in the lateral direction. The front end 554 and the back end 556 of the blades 544, 546 meet the edge 552 at a chamfered portion.

A plurality of projections 574 extend from the edges 552. The projections 574 serve to increase a longitudinal traction of the track attachment 500, for example to assist in driving the wheel forward across particularly slick surfaces, such as ice. In this manner, the beneficial floating effect of the track attachment 500 is combined with increased gripping ability for both longitudinal and lateral traction. The arrangement is particularly beneficial where both hard, slick surfaces and soft, loose surfaces are encountered, such as in combinations of snow and ice. In use, the blades 544, 546 flare against a surface such that the projections 574 contact and increase friction against said surface.

In varying embodiment, the projections 574 may have a greater rigidity than the remainder of the first lateral blade 544 and the second lateral blade 546. For example, the projections 574 may be formed from a harder material. In one example, the projections 574 may include metal spikes secured or insert molded to the blades 544, 546. The projections 574 may be mounted to the blades 544, 546, or may extend through a height of the blades 544, 546, further increasing the strength of the blades 544, 546 at certain points. Additional friction enhancing materials and/or designs may be incorporated in the track attachments 500 of the current disclosure, as may be understood from the current disclosure by one skilled in the art.

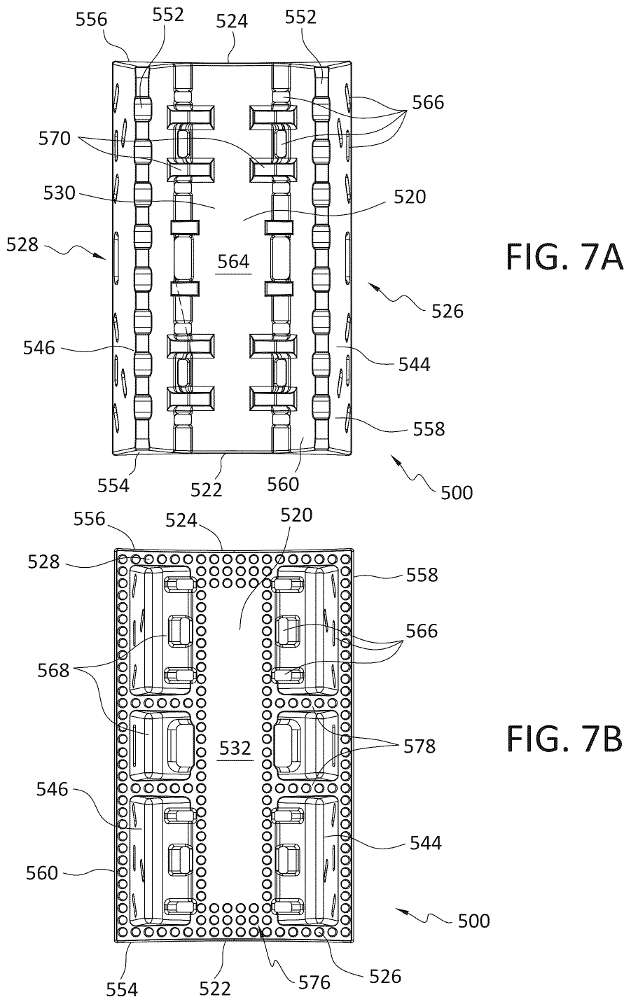

As seen in FIG. 7B, an embodiment of the track attachment 500 may comprise a plurality of protrusions 576, bumps, recesses, or the like arranged on the concave surface 532 of the track body 520 for increasing friction against the wheel or tire. The protrusions 576 may be configured with a size and shape corresponding to a tread pattern of a tire. For example, the plurality of protrusions 576 may be configured to fit into recesses of the tread pattern. The plurality of projections may be formed by metal inserts, a friction enhancing material, or may be formed in the material of the track body 520. The protrusions 576 in certain embodiments of the track attachment 500 may be configured to be flexible relative to the track body 520, in order to better fit to and prevent sliding against the wheel or tire.

In varying embodiments, protrusions 576 may be provided on the convex surface 530 and/or on the at least one blade 540, such as on the first face 558 and/or the second face 560, as may be desired for increasing traction with the terrain in certain applications of the track attachments 500.

As illustrated in FIGS. 5-8, a plurality of openings 566 may be provided in the first lateral blade 544 and the second lateral blade 546 of the track attachment 500. The arrangement of the openings 566 in the blades 544, 546 may improve the reliable and secure positioning of the blades 544, 546 when mounting the track attachment 500 to a wheel or tire. The plurality of openings 566 may be arranged with varying orientations and/or sizes to facilitate a customized attachment. For example, a central opening 580 may be provided having a greater size for accommodating a larger connector and openings 566 may be provided forming an angle with a vertex within the longitudinal curve 534. Varying openings 566 may be provided for connecting to a wheel and/or to additional track attachments in a traction system.

According to carrying embodiments, the central opening 580 may be configured for use with a redundant safety strap while the plurality of openings 566 may be configured for use with securing straps. While described as “straps” the connectors or straps may comprise any suitable materials or configurations, such as chains, cords, belts, etc.

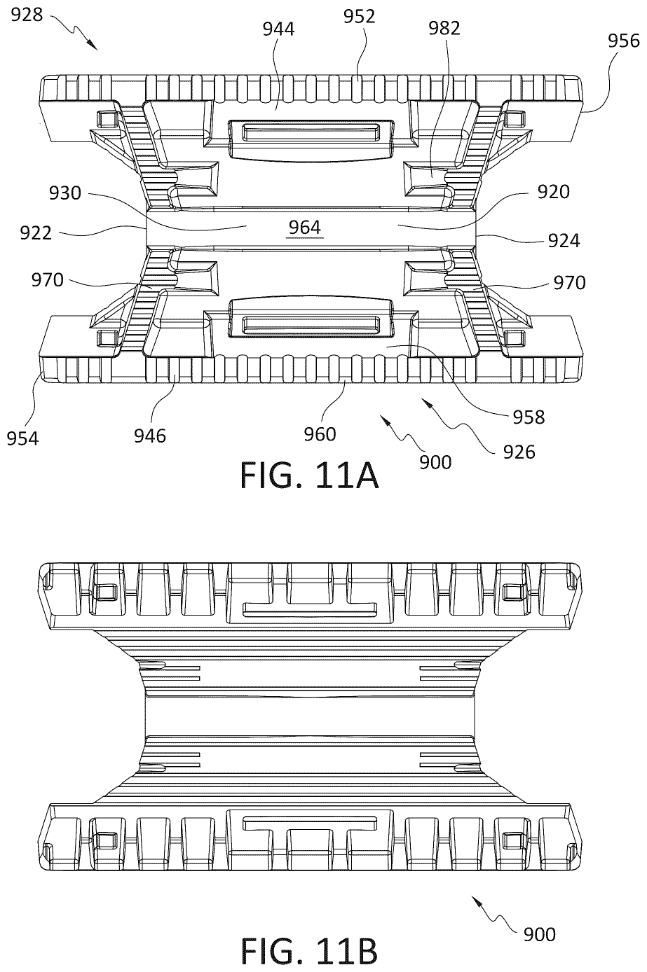

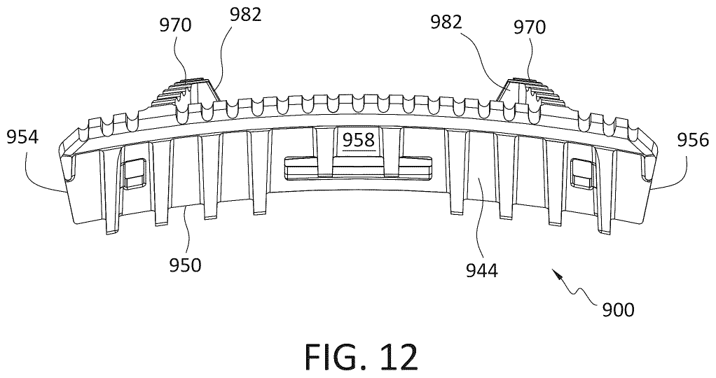

In an embodiment, the openings 566, 580 may form part of a redundant connection system including the securing straps and the redundant safety strap. The securing straps may be arranged to secure the track attachment 500 to the spokes or a similar portion of the wheel, and to other track attachments, while the redundant safety strap may be configured to wrap around the circumference of the tire or wheel in the lateral direction through the central opening 580. The redundant safety strap may be configured to be substantially larger than the securing straps and may attach to the track attachment 500 along a midline of the track attachment 500, as shown in the embodiments of FIGS. 5-8 and FIGS. 9-12. For example, the redundant safety strap may have a cross-sectional area that is 2 to 10 times a cross-sectional area of each of the plurality of securing straps, preferably 3 to 5 times the cross-sectional area of each of the plurality of securing straps.

To accommodate the redundant safety strap, the central opening 580 may be substantially larger than each of the plurality of openings 566. For example, the central opening may have a cross-sectional area that is 2 to 10 times a cross-sectional area of each of the plurality of openings 566, preferably 3 to 5 times the cross-sectional area of each of the plurality of openings 566. The central opening 580 should allow the redundant safety strap to pass substantially under the blades 540, 544, 546 and over the convex surface 530.

The plurality of openings 566 may be arranged for receiving a plurality of securing straps that may serve to tension the track attachment against the curve of the wheel or tire and prevent the track attachment from slipping out of position, while the configuration of the central opening 580 accommodates the redundant safety strap and ensures the track attachment does not separate from the wheel. The configuration of the openings 566, 580 allows for a secure and safe fit without impairing the blades 540, 544, 546 of the track attachment 500 or requiring significant increases in weight and/or materials required for the traction system.

The redundant nature of the connection system ensures that the track attachment 500 is securely positioned and prevents damage or injury in the event of a failure of the connection, which may occur with known devices having only one type of attachment to a wheel. More specifically, should one or more of the plurality of securing straps fail, the track attachment 500 is prevented from completely separating from the wheel by the larger redundant safety strap, even if it may slip along the wheel due to the lack of the securing straps. In like manner, the redundant connection system may be configured to allow varying tension in the track attachment 500. For example, where the plurality of securing straps are more flexible than the redundant safety strap the ends 522, 524 of the track body 520 may shift along the tire in response to the specific terrain encountered while the center of the track attachment 500 remains secure against the tire.

As best seen in FIG. 7B, the first lateral blade 544 and the second lateral blade 546 may be substantially hollow. For example, hollow portions 568 may be provided within the first lateral blade 544 and the second lateral blade 546 defined by interior ribs 578. A position of the interior ribs 578 may be offset relative to that of the ribs 570, or may be substantially aligned therewith. In this manner, a particularly strong track attachment 500 may be formed while a weight of the track attachment 500 may be minimized. The weight of a track attachment 500 is a significant consideration in traction systems according to the present disclosure, as increased weight may impact the handling of a vehicle or otherwise reduce performance. As such, the shapes and configurations of the disclosed track attachments 100, 500 are particularly advantageous in view of the improved results achieved relative to the minor increases in weight necessitated thereby.

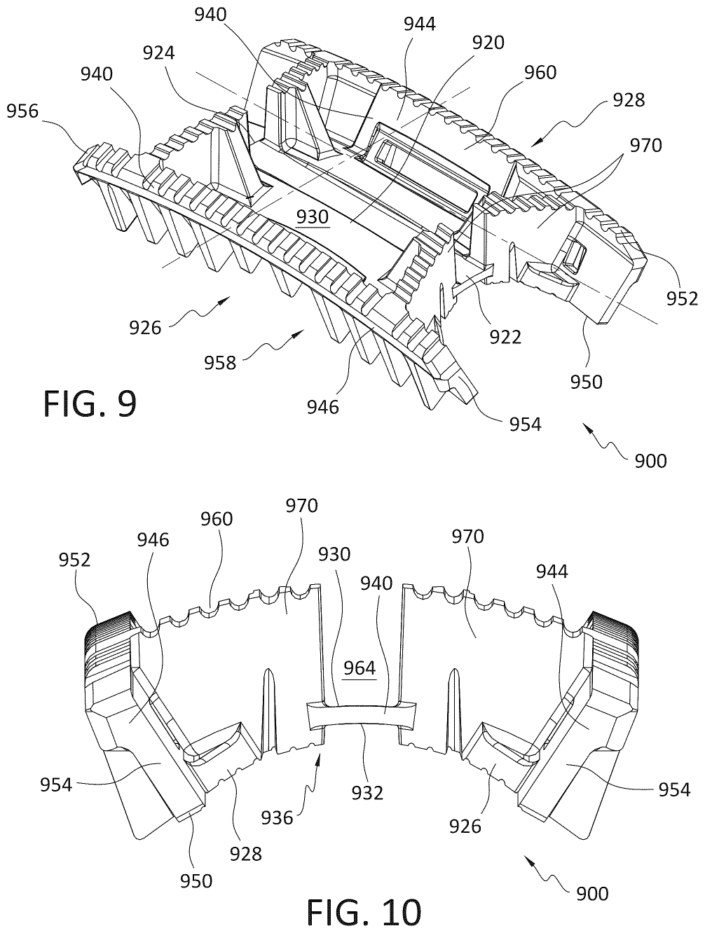

Depicted in FIG. 9 is one embodiment of a track attachment 900 incorporating features of the present disclosure. As discussed below in detail concerning the previous embodiments, track attachment 900 is configured to interface between a wheel and driving terrain, and is designed for improving traction and handling. The driving terrain can include soft or loose terrain, or any other surface or material on or through which the wheel may pass.

As depicted in FIGS. 9-12, track attachment 900 generally comprises a track body 920 extending in a longitudinal direction from a first end 922 to a second end 924 and in a lateral direction perpendicular to the longitudinal direction from a first side 926 to a second side 928. In the depicted embodiment, the track body 920 is shaped to match a segment of a torus shape of a wheel as has been described previously, the track body forming a convex surface 930 and an opposing concave surface 932 where the concave surface 932 of the track body presents a curved profile for contacting the wheel.

The track attachment 900 may include at least one blade 940 connected to the track body 920. The at least one blade 940 includes a base 950 connected to the convex surface 930 of the track body 920 and an opposing edge 952 spaced away from the track body 920, the at least one blade 940 having a front end 954 and a back end 956 extending between the edge 952 and the base 950, a first face 958 and an opposing second face 960 of the at least one blade 940 extending between the edge 952 and the base 950 and also extending between the front end 954 and the back end 956.

A length of the at least one blade 940 may be defined between the front end 954 and the back end 956 in the longitudinal direction and a thickness of the at least one blade 940 may be defined between the first face 958 and the second face 960 in the lateral direction. A height of the at least one blade 940 may be defined between the base 950 and the edge 952.

As shown in FIG. 9, the at least one blade 940 of the depicted embodiment includes a first lateral blade 944 and a second lateral blade 946. In the depicted embodiment, the first lateral blade 944 and the second lateral blade 946 have a length greater than a length of the track body 920, such that the blades 944, 946 extend beyond the track body 920 at both the first end 922 and the second end 924.

As shown in FIG. 10, the track attachment 900 may include a plurality of ribs 970 connected to the at least one blade 940. The ribs 970 may be arranged to buttress the at least one blade 940 in the lateral direction, and may connect the first face 958 and/or the second face 960 to the convex surface 930 of the track body 920. In the depicted embodiment, the ribs 970 may extend from the at least one blade 940 at an angle directed to a center point of the track body 920. The ribs 970 of the embodiment shown in FIG. 10 have an increasing height as they extend from the at least one blade 940. In some embodiments, the increasing height may correspond to a lateral curve 936. A channel 964 separates the ribs 970 along a centerline of the track attachment 900 and longitudinal ribs 982 extend from the ribs 970 in a longitudinal direction to buttress the ribs 970.

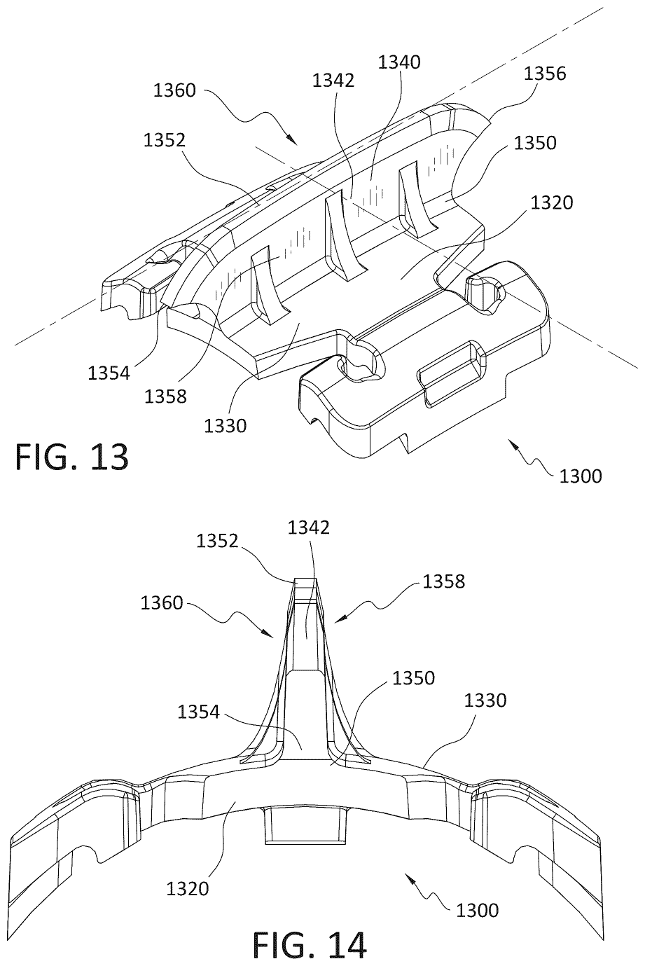

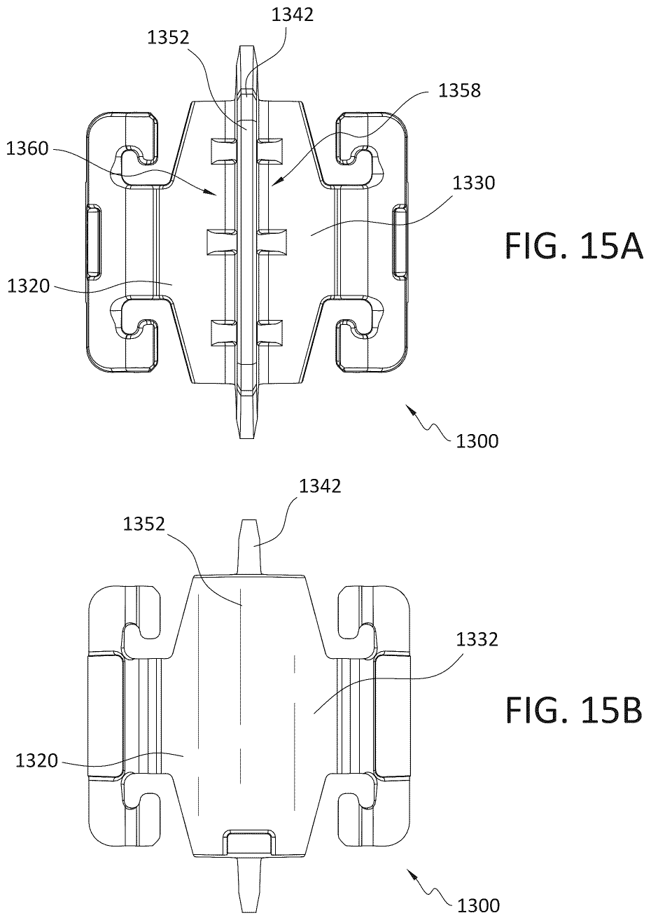

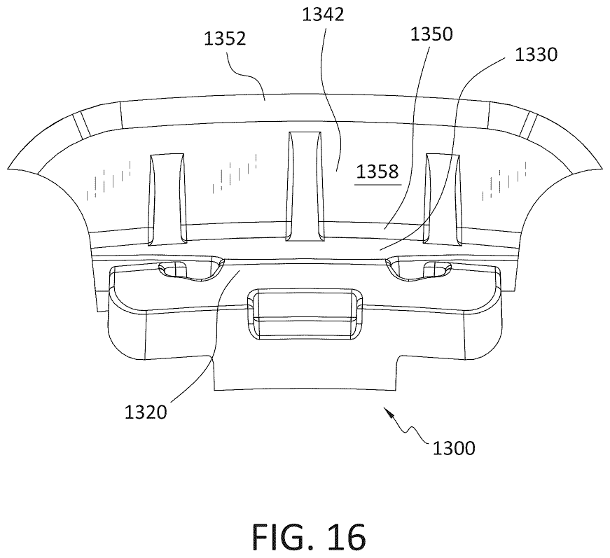

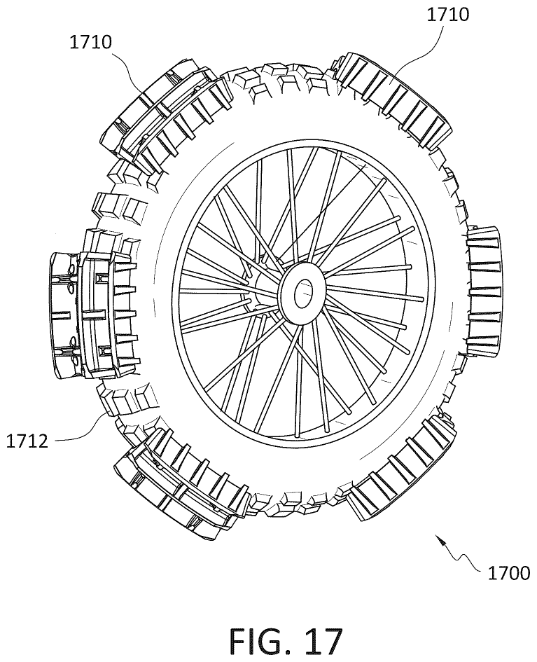

In a further embodiment according to FIGS. 13-16, a track attachment 1300 may include at least one blade 1340 connected to a track body 1320. The at least one blade 1340 including a base 1350 connected to a convex surface 1330 of the track body 1320 and an opposing edge 1352 spaced away from the track body 1320, the at least one blade 1340 having a front end 1354 and a back end 1356 extending between the edge 1352 and the base 1350, a first face 1358 and an opposing second face 1360 of the at least one blade 1340 extending between the edge 1352 and the base 1350 and also extending between the front end 1354 and the back end 1356.

A length of the at least one blade 1340 may be defined between the front end 1354 and the back end 1356 in the longitudinal direction and a thickness of the at least one blade 1340 may be defined between the first face 1358 and the second face 1360 in the lateral direction. A height of the at least one blade 1340 may be defined between the base 1350 and the edge 1352.

As shown in FIG. 13, the at least one blade 1340 of the depicted embodiment includes a central blade 1342 positioned along a central longitudinal axis of the track attachment 1300 perpendicular to the lateral direction, the central blade 1342 substantially dividing the track body 1320 at a midline of the track body. The central blade 1342 is shown having a hooked shape at each of the front end 1354 and the back end 1356.

In the embodiment of FIGS. 13-16, increased lateral traction relative to a floating effect may be provided. Such an embodiment may be particularly suited to high speeds over loose surfaces, where the speed of the vehicle may prevent sinking but the need for lateral traction remains substantial.

Embodiments of the track attachment may form part of a track system 1700 for a vehicle. The track system may include a plurality of track attachments 1710 secured about a wheel 1710 of the vehicle. According to an advantageous embodiment, the wheel may comprise a front wheel, more particularly a front wheel of a two-wheel vehicle or motorcycle.

In various aspects of the system, the track system 1700 may include at least 3 track attachments 1710, at least 4 track attachments 1710, 3 to 20 track attachments 1710, 5 to 15 track attachments 1710, or 6 to 12 track attachments 1710. In certain embodiments, each of the track attachments 1710 in the system may be identical. In alternative embodiments, the plurality of track attachments 1710 may be different. For example, the plurality of track attachments 1710 may be configured having different numbers of blades, sizes, or blade orientations. Each of the plurality of track attachments may include one or more of a first lateral blade, a second lateral blade, and/or a central blade, for example the traction system 1700 may include a plurality of track attachments 1710 alternating between a first lateral blade and a second lateral blade around the wheel 1712.

The plurality of track attachments 1710 may be evenly spaced about the circumference of the wheel. Each of the track attachments 1710 may be secured to spokes of the wheel 1700 by connectors 1714 passing through openings in the track attachments 1710. In an advantageous embodiment, each of the track attachments 1710 may be provided with at least two independent connectors 1714, such that each track attachment 1710 is secured to the wheel at two opposite sides of the track attachment 1710. In another aspect, each of the plurality of track attachments 1710 may be secured to at least two other track attachments 1710.

Embodiments of the track attachment 1710 and traction system 1700 of the current disclosure may be used in a corresponding method for mounting to a wheel 1712 and/or operating a vehicle.

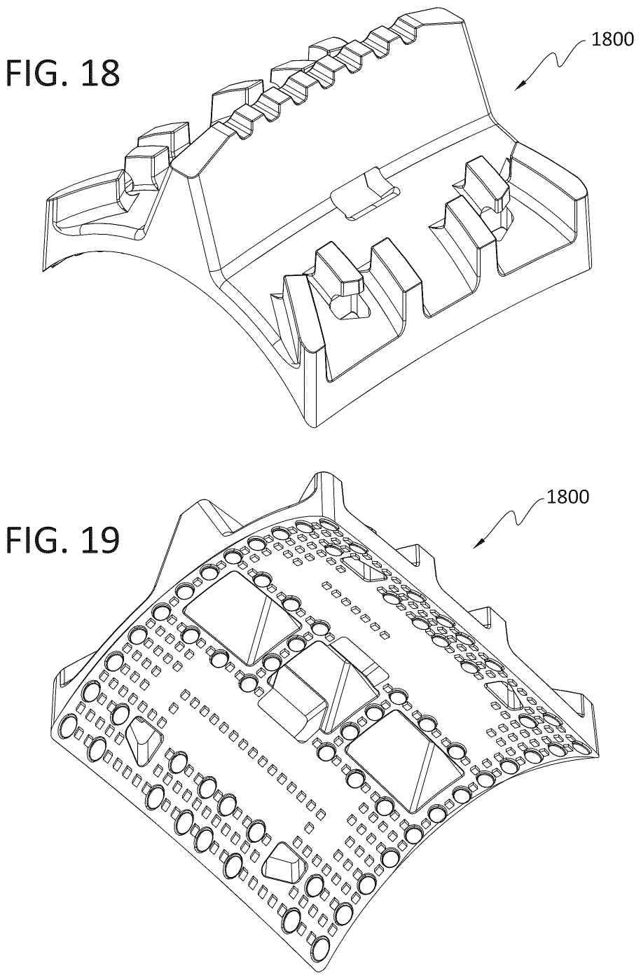

FIGS. 18 and 19 illustrate a further embodiment of a track attachment 1800 combining various features from previously described embodiments into a single-blade embodiment.

Additional embodiments may include track attachments configured for securing to a tire using a lacing and/or strapping configuration. The track attachments may accordingly include alternating and opposing protrusions for lacing a connector or connectors such as a rope, strap, cord, chain, tic, line or the like along the length of the track at each side. The connector may connect a single track to the tire or connect multiple tracks together and to the tire. In some cases, the connector may be configured to interface with tire spokes or other attachment means for securing to the tire. The attachment means may include a clip, carabiner, hook, strap, rope, tic, line, chain, link, or the like. Additional examples may be recognized from the illustrated embodiments of the disclosure, particularly in combination with features of the further embodiments of the current disclosure.

It is to be understood from the current disclosure that the features of the illustrated embodiments may be combined to meet the terrain requirements or characteristics of a wheel or vehicle. Accordingly, embodiments according to the current disclosure may incorporate variations in size, shape, number, orientation and/or location of blades, ribs, projections, protrusions or otherwise in whole or in part from one embodiment to another.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, processes, and/or products according to certain embodiments of the present disclosure may include, incorporate, or otherwise comprise properties features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features without necessarily departing from the scope of the present disclosure.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. A track attachment for use with a wheel, the track attachment comprising:
a track body extending in a longitudinal direction from a first end to a second end and in a lateral direction perpendicular to the longitudinal direction from a first side to a second side, the track body forming a convex surface and an opposing concave surface, the concave surface of the track body defining a longitudinal curve between the first end and the second end and a lateral curve between the first side and the second side, said lateral curve having a degree of curvature greater than a degree of curvature of said longitudinal curvature; and
at least one blade having a base connected to the convex surface of the track body and an opposing edge spaced away from the track body, the at least one blade having a front end and a back end extending between the edge and the base, a first face and an opposing second face of the at least one blade extending between the edge and the base and also extending between the front end and the back end;
wherein a minimum length of the at least one blade extending from the front end to the back end in the longitudinal direction is greater than a maximum thickness of the at least one blade extending from the first face to the second face in the lateral direction.

2. The track attachment of claim 1, wherein the track attachment is symmetrical about a central longitudinal plane bisecting the track attachment perpendicular to the lateral direction.

3. The track attachment of claim 1, wherein the track attachment is symmetrical about a central lateral plane bisecting the track attachment perpendicular to the longitudinal direction.

4. The track attachment of claim 1, wherein the degree of curvature of the longitudinal curve is between 8 and 27 degrees.

5. The track attachment of claim 1, wherein the minimum length of the at least one blade extending from the front end to the back end in the longitudinal direction is at least 50% of a distance between the first end and the second end.

6. The track attachment of claim 5, wherein the minimum length of the at least one blade extending from the front end to the back end in the longitudinal direction is greater than the distance between the first end and the second end.

7. The track attachment of claim 5, wherein the minimum length of the at least one blade extending from the front end to the back end in the longitudinal direction is greater than a height extending from the base to the edge.

8. The track attachment of claim 1, wherein a thickness of the at least one blade extending from the first face to the second face in the lateral direction decreases from the base to the edge.

9. The track attachment of claim 1, wherein the first side of the track body defines a first opening for receiving a fastener secured to the wheel and the second side of the track body defines a second central opening for receiving the fastener secured to the wheel.

10. The track attachment of claim 9, wherein the first side of the track body defines at least one first opening for receiving at least one fastener secured to the wheel or around the rim of the wheel and the second side of the track body defines a second at least one opening for receiving the at least one fastener secured to the wheel or around the rim of the wheel.

11. The track attachment of claim 1, wherein the track body and/or the at least one blade comprise a polyurethane, polyamide or aluminum based material.

12. The track attachment of claim 1, wherein the track body and the at least one blade are integrally formed.

13. The track attachment of claim 1, further comprising a plurality of ribs, each of the plurality of ribs extending from one of the first face or the second face of the at least one blade to the track body.

14. The track attachment of claim 1, wherein the edge of the at least one blade includes a plurality of protrusions for enhancing friction between the track and the ground.

15. The track attachment of claim 1, wherein the at least one blade comprises a central blade connected to the convex surface along a center plane bisecting the track attachment perpendicular to the lateral direction.

16. The track attachment of claim 15, wherein the at least one blade further comprises a first lateral blade and a second lateral blade, wherein the first lateral blade and the second lateral blade are equally spaced apart from the center plane.

17. The track attachment of claim 1, wherein the at least one blade comprises a first lateral blade and a second lateral blade, wherein the first lateral blade and the second lateral blade are equally spaced apart from a center plane bisecting the track attachment perpendicular to the lateral direction.

18. A track system comprising:
a wheel including a lateral circumference around a tire and rim and a plurality of spokes; and
a plurality of track attachments, each track attachment comprising:
a track body extending in a longitudinal direction from a first end to a second end and in a lateral direction perpendicular to the longitudinal direction from a first side to a second side, the track body forming a convex surface and an opposing concave surface, the concave surface of the track body defining a longitudinal curve between the first end and the second end and a lateral curve between the first side and the second side, said lateral curve having a degree of curvature greater than a degree of curvature of said longitudinal curvature; and
at least one blade having a base connected to the convex surface of the track body and an opposing edge spaced away from the track body, the at least one blade having a front end and a back end extending between the edge and the base, a first face and an opposing second face of the at least one blade extending between the edge and the base and also extending between the front end and the back end;
wherein a minimum length of the at least one blade extending from the front end to the back end in the longitudinal direction is greater than a maximum thickness of the at least one blade extending from the first face to the second face in the lateral direction.

19. The track system of claim 18, wherein each of the plurality of track attachments is secured around the lateral circumference of the tire and rim with at least one strap per track attachment.

20. The track system of claim 18, wherein each of the plurality of track attachments is secured directly to at least two of the plurality of spokes by one or more fasteners and is secured directly about a lateral circumference of the tire and rim by at least one redundant safety fastener, or
wherein each of the plurality of track attachments is secured directly to at least two others of the plurality of track attachments.
